(19) United States
(12) Patent Application Publication
(10) Pub. No.: US 2026/0220463 A1
(43) Pub. Date: Jul. 30, 2026

(54) METHOD AND SYSTEM FOR HYBRID LLM COMPRESSION

(71) Applicant: Samsung Electronics Co., Ltd., Gyeonggi-do (KR)

(72) Inventors: Jingoo HAN, San Jose, CA (US); Sungwook JUNG, San Diego, CA (US); Joon Hee CHOI, Campbell, CA (US)

(21) Appl. No.: 19/037,062

(22) Filed: Jan. 24, 2025

(51) Int. Cl. G06N 3/082; G06N 3/0495; G06N 3/0985

(52) U.S. Cl. CPC G06N 3/082; G06N 3/0495; G06N 3/0985

(57) ABSTRACT

A method and apparatus are disclosed. The method comprises storing data representing a large language model (LLM) in a storage medium; receiving a quality of service (QoS) requirement specified by a user, wherein the QoS requirement includes a value representing at least one of a desired accuracy and a desired compression ratio; selecting a compression algorithm based on the QoS requirement, wherein the compression algorithm is chosen to balance the at least one of the desired accuracy and the desired compression ratio; and compressing the data representing the LLM using the selected compression algorithm.

### CROSS-REFERENCE TO RELATED APPLICATION

This application claims the priority benefit under 35 U.S.C. § 119(e) of U.S. Provisional Application No. 63/693,392, filed on Sep. 11, 2024, the entire contents of which are incorporated herein by reference.

### TECHNICAL FIELD

The disclosure generally relates to methods and systems for compression routines (algorithms) of machine learning (ML) models. More particularly, the subject matter disclosed herein relates to improvements in adaptive and quality of service (QoS)-aware compression techniques for large language models (LLMs) to optimize storage efficiency and model accuracy based on dynamic user requirements.

### BACKGROUND

LLMs are frequently encountered in artificial intelligence (AI) systems, particularly in natural language processing tasks. However, these models require substantial storage resources due to their large size. This demand for storage becomes costly and limits the efficient deployment of LLMs, especially in resource-constrained environments such as network edge devices or data centers.

To solve this problem, some approaches have employed fixed compression techniques such as quantization, pruning, and fixed lossless or lossy compression routines. These methods can provide a reduction in model size but often result in a trade-off between compression efficiency and model accuracy. Current solutions often lack adaptability, applying the same compression method regardless of specific application requirements, which limits flexibility and efficiency.

One issue with the above approach is that it fails to consider varying user QoS requirements, which may emphasize accuracy over storage efficiency or vice versa. Additionally, some compression methods cannot dynamically adapt to changes in user demands or model characteristics, leading to suboptimal performance in either accuracy retention or compression ratio.

### SUMMARY

To overcome these issues, systems and methods are described herein for a hybrid LLM compression routine that dynamically selects the optimal compression strategy based on QoS criteria, such as accuracy and storage requirements. This hybrid approach incorporates both lossy and lossless compression techniques and uses an adaptive selection mechanism to balance model size reduction with minimal accuracy loss, meeting user-defined QoS thresholds.

The above approaches improve on previous methods because they allow for flexible, QoS-aware compression that adjusts dynamically to changing needs, maximizing storage efficiency without compromising model accuracy. This adaptability provides improved storage utilization, supports diverse application requirements, and enhances the overall deployment efficiency of LLMs.

In an embodiment, a method comprises storing data representing an LLM in a storage medium; receiving a QoS requirement specified by a user, wherein the QoS requirement includes a value representing at least one of a desired accuracy and a desired compression ratio; selecting a compression algorithm based on the QoS requirement, wherein the compression algorithm is chosen to balance the at least one of the desired accuracy and the desired compression ratio; and compressing the data representing the LLM using the selected compression algorithm.

In an embodiment, an apparatus comprises a storage medium configured to store data representing an LLM; and a processor. The processor is configured to receive a QoS requirement specified by a user, wherein the QoS requirement includes a value representing at least one of an accuracy of inference results and a compression model storage size; select a compression model based on the QoS requirement, wherein the compression model is chosen to optimize the accuracy of inference results or the compression model storage size; and compress the data representing the LLM using the selected compression model.

### BRIEF DESCRIPTION OF THE DRAWING

In the following section, the aspects of the subject matter disclosed herein will be described with reference to exemplary embodiments illustrated in the figures, in which:

FIG. 1 is a block diagram illustrating a conventional fixed LLM compression approach, according to an embodiment; and

FIG. 2 is a block diagram illustrating a hybrid LLM compression approach, according to an embodiment; and

FIG. 3 is a table illustrating how a hybrid LLM compression algorithm dynamically balances accuracy and compression size based on QoS requirements, according to an embodiment; and

FIG. 4 is a block diagram illustrating an adaptative compression selection process of a compression algorithm selector, according to an embodiment;

FIG. 5 is a hybrid LLM compression routine, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Large language model” (or “LLM”) as used herein may refer to an AI model that has been pre-trained on text data and comprises a substantial number of parameters. Some non-limiting examples of “LLMs” are models designed for natural language processing tasks, such as text generation, text classification, or question-answering.

“Data representing an LLM” as used herein may refer to the data that defines the weights, parameters, and other structural elements of an LLM. Some non-limiting examples of “data representing an LLM” are weight matrices, parameter files, and other configuration data that enable the LLM to perform inferencing tasks.

“Inference results” as used herein may refer to the outputs generated by the LLM when it processes input data. Some non-limiting examples of “inference results” are predictions, classifications, and responses produced by the LLM in response to a user query or input.

A “quality of service” (or “QoS”) requirement as used herein may refer to a specification defined by a user system/device that includes one or more values or parameters representing an acceptable level of accuracy for inference results, a desired storage size for the compressed model, or a tradeoff between accuracy and storage efficiency. Some non-limiting examples of “QoS” requirements are settings that prioritize high accuracy, settings that prioritize storage efficiency, or configurations that balance accuracy and compression size.

“Compression algorithm” as used herein may refer to an algorithm, routine or technique applied to reduce the storage size of data, for example, the data representing an LLM. Some non-limiting example types of “compression models” are lossless compression, lossy compression, and near-lossless compression models.

“Lossless compression algorithm” as used herein may refer to a compression technique that reduces the storage size of data, for example, the data representing an LLM without any loss of accuracy in the data. Some non-limiting examples of “lossless compression algorithms” are algorithms that retain the full fidelity of the LLM data while reducing its storage requirements. For example, a “lossless compression algorithm” may include at least one of a Huffman encoding algorithm, a run-length encoding (RLE) algorithm, or a Lempel-Ziv-Welch (LZW) algorithm. Other algorithms may also be used.

“Lossy compression algorithm” as used herein may refer to a compression technique that reduces the storage size of data, for example, the data representing an LLM, by allowing some loss of accuracy in the data. Some non-limiting examples of “lossy compression algorithms” are compression algorithms that reduce a model size more significantly than lossless methods but may introduce small inaccuracies in inference results. For example, a “lossy compression algorithm” may include at least one of various quantization algorithms (e.g., 8-bit or 4-bit quantization) or a pruning algorithm, where less significant model weights or parameters are reduced or removed. Other algorithms may also be used.

“Compression cost” as used herein may refer to a calculated value that represents the impact of a selected compression algorithm on both the accuracy of data (as it relates to the accuracy of the inference results) and the storage size of the compressed model. Some non-limiting examples of “compression cost” calculations include metrics that weigh both accuracy and storage efficiency of a compression algorithm, to guide the selection of an optimal compression algorithm.

LLMs may be preferred for use in natural language processing and other AI-driven applications due to their ability to process and generate human-like text. However, these models can be very large, often requiring substantial storage space and computational resources to handle their numerous parameters. As the size of LLMs continues to grow, so does the need for effective compression techniques that can reduce storage demands while maintaining model performance. Some methods, such as quantization, pruning, and standard lossy or lossless compression routines, offer fixed solutions that reduce model size but often sacrifice accuracy or fail to adapt to specific user needs.

Lossless compression provides little to no loss in accuracy because it may allow data to be reproduced with 100% fidelity to the original data. This means that any subsequent use of the data, such as performing inferences with the LLM, can be carried out with maximal accuracy, since compressed data may retain the full integrity of the original data.

In contrast, lossy compression may achieve a higher compression rate by reducing the fidelity of the data. The original data cannot be fully reproduced after lossy compression, which may introduce some inaccuracies in the compressed data. As a result, use of the lossy compressed data, such as inference, operates with a degree of inaccuracy due to potential information loss. Therefore, when accuracy is prioritized over storage savings, the system may select a lossless compression routine. Conversely, when reducing storage requirements is more critical than preserving accuracy, a lossy compression routine may be chosen.

One or more embodiments described herein address these limitations with a hybrid LLM compression routine that dynamically adjusts the compression strategy based on QoS requirements, such as accuracy and storage constraints. This approach may integrate both lossy and lossless compression methods, leveraging the benefits of each type while mitigating their drawbacks. By analyzing the LLM's characteristics and the user's specific accuracy or storage requirements, the system may select the optimal compression method. For instance, in cases where accuracy is paramount, the system may choose a lossless or near-lossless routine; conversely, if storage efficiency is prioritized, it can apply a high-compression, lossy method with an acceptable level of accuracy loss.

This adaptive, QoS-aware approach can provide significant advantages over fixed compression techniques by offering a flexible and efficient means to compress large models without compromising critical performance metrics. Through the hybrid LLM compression routine, data centers and resource-limited environments such as network-edge devices can achieve enhanced storage utilization and more efficient deployment of LLMs.

Furthermore, the hybrid LLM compression routine may be implemented on network devices such as cloud data centers, which may service large-scale AI/ML applications. Cloud providers may benefit by using LLM compression to minimize storage costs and computational overhead associated with deploying LLMs.

In some cases, the system's QoS requirements may be obtained and applied by cloud service providers based on the specific needs of their user groups or use-case scenarios. For example, certain types of services that interact with cloud service providers may entail different QoS requirements. These types of services may include Internet protocol television (IPTV), online gaming, video on demand (VOD), voice over Internet protocol (VoIP), as well as other services.

Moreover, some applications, such as chatbots for online gaming, may have QoS requirements that prioritize storage efficiency over accuracy, making high-compression lossy models more ideal. Conversely, applications that require high accuracy, such as AI-based code generation, may prefer to use less-compressed models to ensure inference quality, even at higher storage and computational costs. Service providers may dynamically set QoS policies to meet these varied requirements, ensuring that the compression algorithm aligns with the use-case scenarios.

Additionally, the hybrid LLM compression routine may be adaptable to resource-constrained environments such as network-edge devices and on-device AI systems, which may have limited storage capacity, computational power, and energy efficiency, heightening the importance of LLM compression. For example, edge devices used for surveillance may require high accuracy despite limited resources, while mobile devices with multiple AI models may benefit from tailored compression strategies to balance efficiency and performance. Unlike traditional compression techniques that statically route AI models to specific services, the hybrid approach described herein can dynamically adjust compression strategies based on real-time QoS requirements, enabling broader and more efficient deployment of LLMs across diverse platforms.

Accordingly, embodiments disclosed herein enable scalable, cost-effective, and performance-optimized deployment of AI models across various applications.

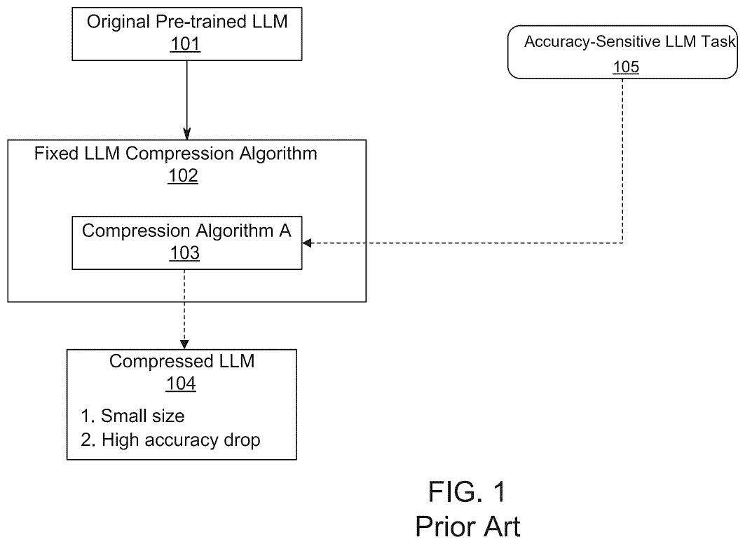

FIG. 1 is a block diagram illustrating a conventional fixed LLM compression approach, according to an embodiment.

Referring to FIG. 1, box 101 represents the “Original Pre-trained LLM”, which is an LLM before any compression has been applied. This pre-trained model requires significant storage resources, so compression is needed to make it more manageable for deployment. Box 102, labeled “Fixed LLM Compression Algorithm,” represents a conventional approach, where a fixed compression method is applied to the model. This approach lacks adaptability, as a specific compression routine is selected without consideration of any specific accuracy or data reduction requirements for the model's intended use.

Within the fixed LLM compression algorithm 102, the figure shows an individual compression routine. Box 103, labeled “Compression Algorithm A,” represents an algorithm that provides a high compression rate, reducing the LLM model to a much smaller size, as shown in box 104. However, this high level of compression comes at the cost of a substantial accuracy drop, which makes this option less suitable for applications that require a high model accuracy.

Box 105 represents an “Accuracy-Sensitive LLM Task,” which illustrates an application where high accuracy is desired. The LLM task 105 may be a request to access a compressed LLM to perform a processing task, such as natural language processing. The LLM task 105 may be received from a remote device, such as an electronic device, a user equipment, or another network device. Alternatively, the LLM task 105 may be received from a component on the same device on which the fixed LLM compression algorithm 102 is stored.

The conventional approach shown in FIG. 1 is a fixed approach that applies the compression algorithm A 103 to the original pre-trained LLM to generate the compressed LLM 104 regardless of size and/or accuracy preferred for the LLM task 105. However, the high accuracy drop produced by compression algorithm 103 makes using the compressed LLM 104 undesirable for this type of LLM Task 105 since the LLM Task 105 is accuracy-sensitive. Therefore, it may be more desirable to use a different compression algorithm to generate a compressed LLM instead of the compression algorithm 103, which generates a compressed LLM with a high accuracy drop, for the accuracy-sensitive LLM task 105. Thus, FIG. 1 illustrates a drawback of the fixed LLM compression approach because it lacks flexibility to adapt to the varying needs of accuracy and data reduction, resulting in suboptimal performance for tasks that require a specific balance between these two factors.

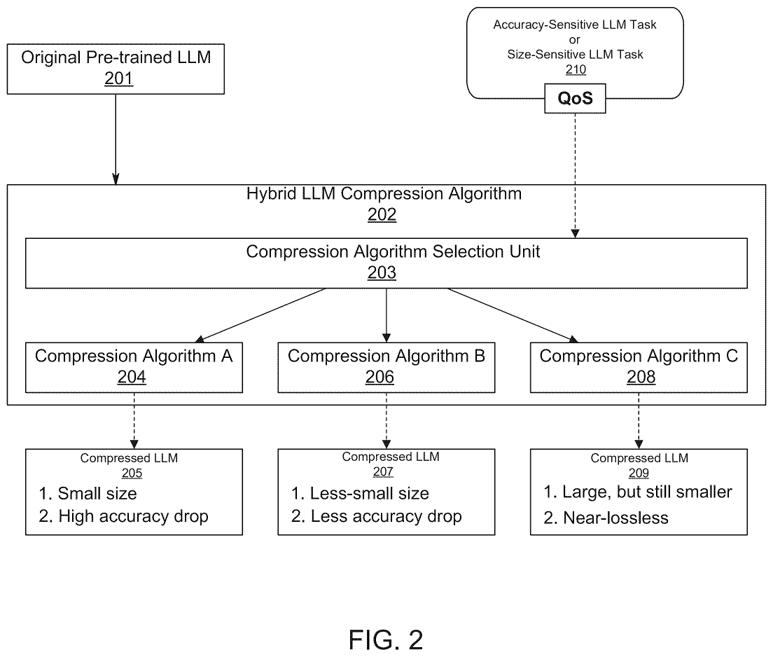

FIG. 2 is a block diagram illustrating a hybrid LLM compression approach, according to an embodiment.

As discussed below in FIG. 2, the hybrid LLM compression algorithm may be an adaptive system that can select the most appropriate compression method based on specific QoS requirements, such as accuracy or size sensitivity. Referring to FIG. 2, box 201 represents the “Original Pre-trained LLM,” which is an LLM requiring compression before deployment. Box 202, labeled “Hybrid LLM Compression Algorithm,” represents an adaptive system that dynamically selects from multiple compression methods based on the model's intended use and the user's QoS needs. The original pre-trained LLM 201 is applied to the selected compression method to output a compressed LLM.

In this description, the term “user” may be associated with QoS requirements and can refer to various entities or devices. This may include an individual end-user accessing AI/ML services, such as through a smartphone or computer, or an AI/ML service provider managing QoS policies for a group. In some cases, the term may also refer to automated systems or network components that dynamically adjust QoS requirements based on performance metrics or real-time conditions. For instance, an end-user might directly specify QoS requirements through an application interface, while a service provider may determine QoS requirements based on the nature of the service being delivered, such as high accuracy for code generation or low latency for online gaming.

Referring again to FIG. 2, within the hybrid LLM compression algorithm 202, box 203 includes the “Compression Algorithm Selection Unit”, which functions as the decision-making module. This component evaluates requirements (e.g., accuracy of inference results or storage size of a compressed LLM) and selects the appropriate compression algorithm accordingly.

FIG. 2 presents three options for compression algorithms. Although three compression algorithms are shown, more or less may be used. Box 204, labeled “Compression Algorithm A,” represents an algorithm that achieves a high compression rate, resulting in a significantly reduced LLM size shown in box 205, but with a substantial accuracy drop. This option would be appropriate for size-sensitive tasks where storage constraints are a priority over maintaining high accuracy. Box 206, labeled “Compression Algorithm B,” represents an intermediate compression algorithm, yielding a moderately compressed LLM size in box 207 with a lower accuracy drop compared to Algorithm A. This intermediate option offers a balance between size reduction and accuracy retention. In addition, box 208, labeled “Compression Algorithm C,” represents a near-lossless compression method that provides minimal accuracy drop, producing a large, but still smaller, compressed LLM size depicted in box 209. This approach is well-suited for accuracy-sensitive tasks where maintaining the integrity of the model's performance is prioritized.

Each compression algorithm 204, 206, and 206 in the hybrid LLM compression algorithm 202 may have a defined compression ratio, which can determine how much the size of the data representing the LLM is reduced. This compression ratio may directly affect both the accuracy of inference results and the size of the compressed LLM model. Higher compression ratios can lead to greater reductions in model size, which reduces storage requirements and cost. However, these higher compression ratios can also introduce inaccuracies in inference results by removing or altering less critical model parameters. In contrast, lossless compression algorithms, with lower compression ratios, may preserve the original data's fidelity, which can ensure a relatively smaller loss in inference accuracy while resulting in a larger LLM compressed model size, which may require increased storage requirements and cost. Intermediate compression algorithms can provide a balanced approach, which may achieve moderate size reduction while minimizing the impact on accuracy.

Box 210, labeled “Accuracy-Sensitive LLM Task or Size-Sensitive LLM Task,” represents an LLM task with different QoS-driven performance parameters that the hybrid LLM compression algorithm is designed to serve. For example, QoS performance parameters of an LLM task 210 may prioritize accuracy over size (i.e., accuracy-sensitive), or the LLM task 210 may prioritize size over accuracy (i.e., size-sensitive). Based on the QoS performance parameters of a task 210, the compression selection algorithm 203 may select the appropriate compression algorithm 204, 206, or 208 to the perform the corresponding task, which may provide an improved balance between storage efficiency and accuracy. Each compression algorithm 204, 206, and 208 may be associated with a predefined compression ratio. Furthermore, the compression algorithm selection unit 203 may select the compression algorithm 204, 206, and 208 from a plurality of predefined compression algorithms. This plurality may include at least one lossy compression algorithm, one lossless compression algorithm, and one intermediate compression algorithm. Furthermore, some compression algorithms may have adjustable compression ratios allowing the hybrid LLM compression algorithm 202 to fine-tune the balance between storage reduction and accuracy retention based on task-specific requirements. For instance, an adjustable compression ratio may allow a lossy compression algorithm to operate at higher accuracy levels by reducing the compression ratio, or to achieve greater size reduction by increasing it.

The ability to adjust compression ratios may enhance the flexibility of the hybrid LLM compression algorithm 202, which can enable it to respond to real-time changes in QoS requirements or resource availability. For example, during a bandwidth-limited transmission, the algorithm may increase the compression ratio to reduce the model size further, while in a high-accuracy inferencing task, the compression ratio may be reduced to preserve fidelity. This adaptability may ensure that the system can serve a wider range of tasks and environments, further overcoming the limitations of fixed compression methods.

With reference to box 210, each task may have a specific QoS requirement, e.g., high accuracy and/or minimized storage size, which the hybrid LLM compression algorithm 202 considers when selecting the appropriate compression method. Other tasks and/or parameters may be considered in addition to accuracy and size; these are just examples.

In some embodiments, the QoS requirement for the LLM may be dynamically updated based on real-time conditions, such as changes in user priorities, system resource availability, or network performance. For example, if a network connection becomes limited, the QoS requirement may prioritize a smaller compressed LLM to reduce transmission time. Conversely, if computational resources increase or the task requires higher accuracy, the QoS requirement may update to favor a near-lossless compression algorithm. The system may monitor these real-time conditions and automatically re-evaluate the selected compression algorithm based on the updated QoS requirement. Upon detecting a change, the hybrid LLM compression algorithm 202 may calculate a new compression cost (described below with respect to Equation 1) for available compression algorithms and select the algorithm that best aligns with the updated QoS requirement.

In some embodiments, the system may store the compressed LLM data 205, 207, and/or 209 generated by a selected compression algorithm 204, 206, and/or 206 in a storage medium for later use. Compressed LLMs generated by the selected compression algorithm may be stored in storage devices such as SSDs or other filesystems. When needed for inferencing, the compressed LLM can be transferred from storage into another memory (e.g., graphics processing unit (GPU) memory), where it can be executed to provide AI/ML services efficiently.

For example, compressed LLMs optimized for specific QoS requirements may be stored to respond efficiently to future user queries. When a query is received, the system may identify the QoS requirements associated with the query and select the stored compressed LLM that best meets those requirements.

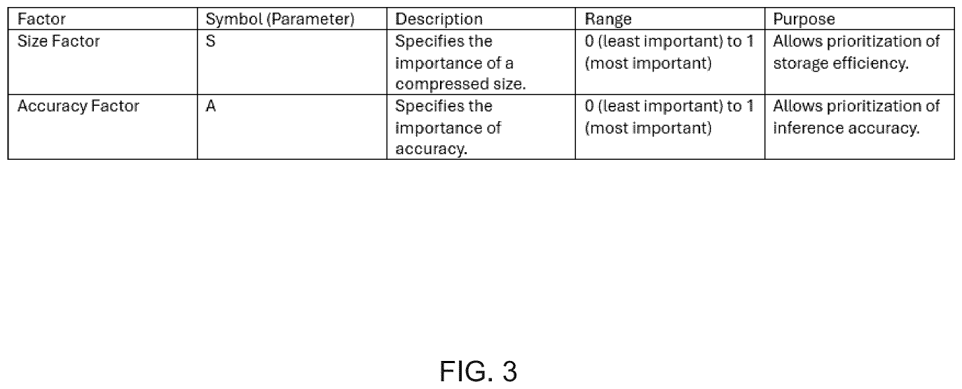

FIG. 3 is a table illustrating how a hybrid LLM compression algorithm dynamically balances accuracy and compression size based on QoS requirements, according to an embodiment.

Referring to FIG. 3, the table represents two factors that guide the selection of the optimal compression algorithm (e.g., compression algorithm 204, 206, or 208): the size factor(S) and the accuracy factor (A). The size factor expresses the importance of achieving a smaller compressed model size, while the accuracy factor expresses the importance of maintaining high accuracy in the inference results. The factors may be specified by the user or device and are represented as values ranging from 0 to 1, where 0 indicates the factor is of least importance and 1 indicates the factor is of most importance.

The table illustrates how the hybrid LLM compression algorithm 202 may use these factors to optimize compression dynamically. For example, when S is set closer to 1 and the accuracy factor A is closer to 0, the algorithm may prioritize compression methods that maximize size reduction, even at the expense of some accuracy. Conversely, when A is set closer to 1 and the S is closer to 0, the algorithm may select near-lossless compression techniques to ensure minimal accuracy loss, even if the resulting model size is larger. Accordingly, the hybrid LLM compression algorithm 202 can dynamically choose between different compression approaches to best meet the QoS needs of various tasks.

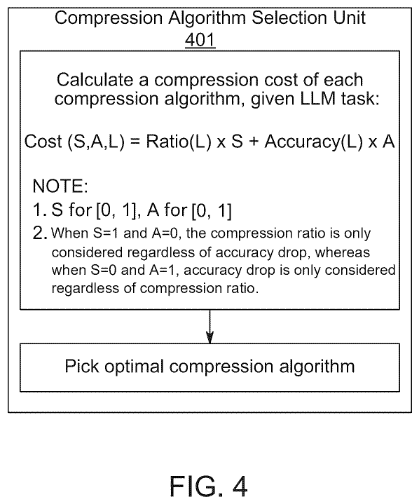

FIG. 4 is a block diagram illustrating an adaptative compression selection process of a compression algorithm selector, according to an embodiment.

FIG. 4 shows how the system chooses the optimal compression algorithm based on QoS requirements, specifically accuracy and size tradeoffs. Referring to FIG. 4, box 401, labeled “Compression Algorithm Selection,” provides a detailed look at the process by which the compression algorithm determines the optimal algorithm for LLM compression. The compression algorithm selection unit 401 may correspond to the compression algorithm selection unit 203 in FIG. 2. The selection process may be based on calculating a “compression cost” for each algorithm (e.g., 204, 206, and 208), defined as a function of size “importance” (S) and accuracy “importance” (A) factors, represented by Equation 1:

Cost (S, A, L)=Ratio(L)×S+Accuracy(L)×a (1)

Here, S and A are scaling factors between 0 and 1 that provide for a relative weighting of the importance of compression ratio versus accuracy drop. Ratio(L) is a compression ratio for a given compression algorithm L, and Accuracy(L) is an accuracy drop for a given compression algorithm L. Compression ratios may be inversely correlated to accuracy drops for a given compression algorithm L, since higher compression ratios typically involve more aggressive data reduction techniques, such as lossy compression. Conversely, lower compression ratios, such as those achieved with lossless or near-lossless compression, preserve more of the original model's fidelity, resulting in minimal accuracy loss.

When S is set to 1 and A to 0, the system may prioritize a compression ratio and ignore accuracy; conversely, when S is 0 and A is 1, the system may prioritize accuracy and ignore compression ratio. This calculation can provide a cost value based on S, A, and L, which may be used to evaluate and guide the selection of the compression algorithm that best meets the user-defined QoS requirements.

The system may select the compression algorithm with the lowest calculated compression cost, thereby optimizing the balance between model size and accuracy based on the QoS requirements. Accordingly, FIG. 4 illustrates how the hybrid LLM compression algorithm adaptively selects the best compression method for a given scenario, making it more efficient and flexible than fixed compression approaches.

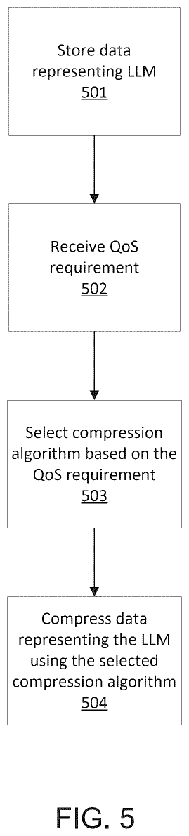

FIG. 5 is a hybrid LLM compression routine, according to an embodiment.

The hybrid LLM compression routine shown in FIG. 5 may be performed by a system such as a data center, an edge computing device, or another networked device. The system may include components such as a processor, memory, storage medium, and communication modules.

In step 501, data representing an LLM is stored. This data may be stored in a storage medium, such as an SSD, database, or memory. In some embodiments, the data may be stored in its original uncompressed form, while in others, it may already be partially compressed or optimized for specific use cases. The storage location could be local to the device performing the compression, such as onboard storage in an edge device, or remote, such as a cloud-based repository accessible over a network. Alternative embodiments may allow for distributed storage across multiple devices or nodes to facilitate scalability and redundancy.

In step 502, a QoS requirement is received. The QoS requirement can specify user-defined or system-defined preferences related to the desired performance of the compressed LLM. This requirement may include parameters such as accuracy of inference results, desired storage size, latency constraints, or compression cost. QoS requirements that are specified by a user may be transmitted from a client device (e.g., smartphone or computer) and/or determined autonomously by the system based on the operational context or application. For example, a cloud service provider may define QoS policies for a specific task, such as prioritizing high accuracy for AI-based code generation or prioritizing storage efficiency for chatbot applications in online gaming. As discussed throughout this disclosure, many other policies and tasks are possible. The QoS requirement can also be dynamically updated based on changing conditions or user input.

In step 503, a compression algorithm is selected based on the QoS requirement. The system may analyze the received QoS requirement and evaluate available compression algorithms to determine which best balances the specified parameters. For example, if high accuracy is desired, the system may select a near-lossless or lossless compression algorithm that minimizes accuracy loss. Conversely, if a high compression ratio resulting in better storage efficiency is desired, a high-compression lossy algorithm may be selected. The selection process may involve calculating a compression cost, considering factors such as compression ratio and accuracy drop, and choosing an algorithm that minimizes this cost. In some embodiments, the selection may also consider additional factors, such as the characteristics of the LLM itself (e.g., model sparsity or parameter distribution) or the computational resources available for compression.

In step 504, the data representing the LLM is compressed using the selected compression algorithm. The compression algorithm may reduce the size of the LLM data while balancing the tradeoff between accuracy and storage efficiency as specified in the QoS requirement. The compressed LLM may then be stored for future use, transferred to another system for inferencing, and/or loaded into dedicated memory (e.g., GPU) for execution. In some embodiments, the compression process may involve multiple passes, adjusting the compression level iteratively to refine the balance between size reduction and accuracy retention. Alternative embodiments may implement hybrid compression techniques that combine multiple algorithms, leveraging the strengths of each to achieve optimal results.

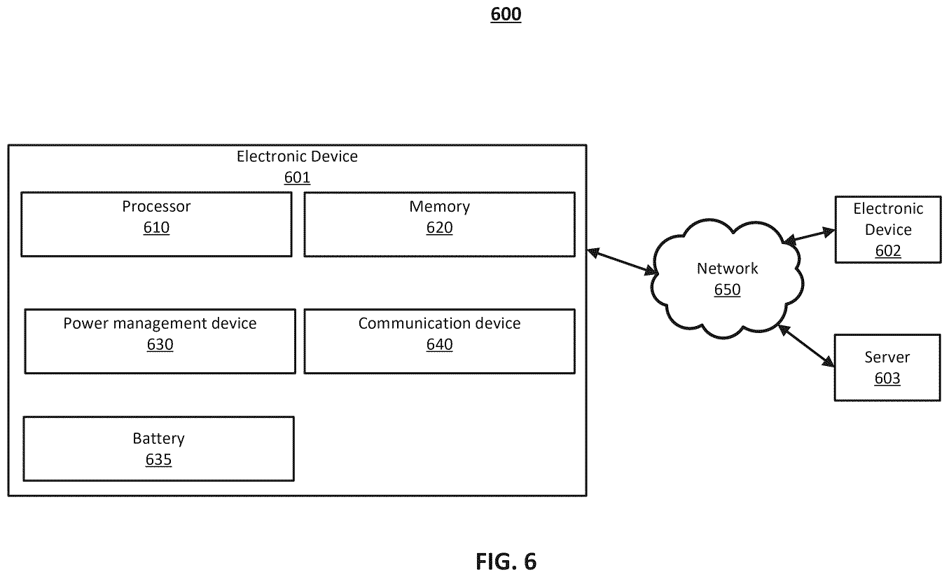

FIG. 6 is a block diagram of an electronic device in a network environment, according to an embodiment.

Referring to FIG. 6, an electronic device 601 in a network environment 600 may communicate with an electronic device 602 or a server 603 via a network 650 or a server 608. The electronic device 601 may include a processor (“controller”) 610, a memory 620, a power management device 630, and a communication device 640. In one embodiment, at least one of the components may be omitted from the electronic device 601, or one or more other components may be added to the electronic device 601.

In the context of the hybrid LLM compression routine, the processor 610 and memory 620 may be used to execute and store the hybrid LLM compression algorithm including the compression algorithm selection unit. The processor 610 may be responsible for running the compression algorithm selection unit, evaluating each compression algorithm based on user-specified QoS requirements, such as the tradeoff between accuracy and model size. The memory 620 may store the pre-trained LLM data, as well as the various compressed versions of the model generated by different algorithms. This memory component can also hold data regarding the specific QoS parameters, such as accuracy thresholds and compression ratios, which may guide the adaptive selection process. Through efficient data management and algorithm execution, one or more embodiments disclosed herein may enhance the performance of processor 610 by optimizing its workload, allowing it to dynamically adjust compression methods without requiring excessive processing resources.

The communication device 640 may enable the electronic device 601 to transmit and receive compressed model data across network environments 650, facilitating interaction with the electronic device 602 and server 603. In scenarios where the electronic device 601 needs to transmit a compressed LLM for remote inferencing, the communication device 640 can select the compressed model version that aligns best with the network's bandwidth capabilities or the remote device's storage constraints. This feature may realize efficient distribution of model data across various network types while minimizing latency and ensuring that the model's accuracy meets the specified QoS requirements. By selecting and transmitting the optimally compressed model, one or more embodiments disclosed herein may reduce bandwidth consumption and enhance network performance, offering a technical improvement to the communication device 640.

Furthermore, the power management device 630 and battery 635 may benefit from efficient compression strategies. By minimizing the size of model data that needs to be stored and processed, the hybrid LLM compression algorithm can reduce the overall energy consumption required for model inferencing, thereby extending the battery life of electronic device 601. This can be particularly advantageous in mobile or resource-constrained environments where power efficiency is prioritized. The reduction in processing demand also minimizes heat generation, which helps to preserve the longevity of both the battery 635 and power management device 630. Through adaptive and efficient data handling, various embodiments disclosed herein contribute to the overall durability and energy efficiency of the electronic device 601.

Furthermore, the processor 610 may execute software (e.g., a program) to control at least one other component (e.g., a hardware or a software component) of the electronic device 601 coupled with the processor 610 and may perform various data processing or computations.

As at least part of the data processing or computations, the processor 610 may load a command or data received from another component in memory 620 (e.g., volatile memory) process the command or the data stored in the volatile memory, and store resulting data in non-volatile memory. The memory 620 may store various data used by at least one component (e.g., the processor 610) of the electronic device 601. The various data may include, for example, software (e.g., a program) and input data or output data for a command related thereto. The memory 620 may include volatile memory or non-volatile memory. Non-volatile memory may include internal memory and/or external memory.

The battery 635 may supply power to at least one component of the electronic device 601. The battery 635 may include, for example, a primary cell which is not rechargeable, a secondary cell which is rechargeable, or a fuel cell.

The communication device 640 may support establishing a direct (e.g., wired) communication channel or a wireless communication channel between the electronic device 601 and another electronic device (e.g., the electronic device 602 or the server 608) and performing communication via the established communication channel. The communication device 640 may include one or more communication processors that are operable independently from the processor 610 and supports a direct (e.g., wired) communication or a wireless communication. The communication device 640 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). Commands or data may be transmitted or received between the electronic device 601 and the electronic device 602 via the server 603. The electronic device 601 may be a device of a same type as, or a different type, from the electronic device 601. All or some of operations to be executed at the electronic device 601 may be executed at one or more of the electronic devices 602 or server 603. For example, if the electronic device 601 should perform a function or a service automatically, or in response to a request from a user or another device, the electronic device 601, instead of, or in addition to, executing the function or the service, may request the one or more of the electronic device 602 and/or server 603 to perform at least part of the function or the service. The electronic device 602 and/or server 603 receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple compact disks (CDs), disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
storing data representing a large language model (LLM) in a storage medium;
receiving a quality of service (QoS) requirement specified by a user, wherein the QoS requirement includes a value representing at least one of a desired accuracy and a desired compression ratio;
selecting a compression algorithm based on the QoS requirement, wherein the compression algorithm is chosen to balance the at least one of the desired accuracy and the desired compression ratio; and
compressing the data representing the LLM using the selected compression algorithm.

2. The method of claim 1, wherein the QoS requirement value indicates a ratio between the desired accuracy and the desired compression ratio.

3. The method of claim 2, wherein selecting the compression algorithm includes calculating a compression cost based on the desired accuracy and the desired compression ratio, and
wherein selecting the compression algorithm minimizes the compression cost.

4. The method of claim 1, wherein compressing the data comprises applying a lossless compression algorithm when the QoS requirement prioritizes the accuracy.

5. The method of claim 1, wherein compressing the data comprises applying a lossy compression algorithm when the QoS requirement prioritizes the desired compression ratio.

6. The method of claim 1, further comprising storing the compressed LLM data generated by the compression algorithm for use based on a query.

7. The method of claim 1, wherein the QoS requirement is dynamically updated based on real-time conditions, and
wherein the method further comprises re-evaluating and re-selecting the compression algorithm based on the updated QoS requirement.

8. The method of claim 1, wherein selecting the compression algorithm comprises selecting from a plurality of compression algorithms, each associated with a predefined compression ratio and accuracy level.

9. The method of claim 8, wherein the plurality of compression algorithms includes at least one lossless compression algorithm and at least one lossy compression model.

10. The method of claim 1, wherein selecting the compression algorithm comprises selecting from a plurality of compression algorithms, including at least one lossy compression algorithm, one lossless compression algorithm, and one intermediate compression algorithm.

11. An apparatus comprising:
a storage medium configured to store data representing a large language model (LLM); and
a processor configured to:
receive a quality of service (QoS) requirement specified by a user, wherein the QoS requirement includes a value representing at least one of a desired accuracy and a desired compression ratio;
select a compression algorithm based on the QoS requirement, wherein the compression algorithm is chosen to balance the at least one of the desired accuracy and the desired compression ratio; and
compress the data representing the LLM using the selected compression algorithm.

12. The apparatus of claim 11, wherein the QoS requirement value indicates a ratio between the desired accuracy and the desired compression ratio.

13. The apparatus of claim 12, wherein selecting the compression algorithm includes calculating a compression cost based on the desired accuracy and the desired compression ratio, and
wherein selecting the compression algorithm minimizes the compression cost.

14. The apparatus of claim 11, wherein compressing the data comprises applying a lossless compression algorithm when the QoS requirement prioritizes the accuracy.

15. The apparatus of claim 11, wherein compressing the data comprises applying a lossy compression algorithm when the QoS requirement prioritizes the desired compression ratio.

16. The apparatus of claim 11, wherein the processor is further configured to store the compressed LLM data generated by the compression algorithm for use based on a query.

17. The apparatus of claim 11, wherein the QoS requirement is dynamically updated based on real-time conditions, and
wherein the processor is further configured to re-evaluate and re-select the compression algorithm based on the updated QoS requirement.

18. The apparatus of claim 11, wherein selecting the compression algorithm comprises selecting from a plurality of compression algorithms, each associated with a predefined compression ratio and accuracy level.

19. The apparatus of claim 18, wherein the plurality of compression algorithms includes at least one lossless compression algorithm and at least one lossy compression algorithm.

20. The apparatus of claim 11, wherein selecting the compression algorithm comprises selecting from a plurality of compression algorithms, including at least one lossy compression algorithm, one lossless compression algorithm, and one intermediate compression algorithm.
